(19) United States
(12) Patent Application Publication
(10) Pub. No.: US 2023/0306196 A1
(43) Pub. Date: Sep. 28, 2023

(54) SYSTEM AND METHOD FOR SPELLING CORRECTION

(71) Applicant: Flipkart Internet Private Limited, Bengaluru (IN)

(72) Inventors: Vishal Kakkar, Bengaluru (IN); Surender Kumar, Bengaluru (IN); Chinmay Sharma, Bengaluru (IN)

(21) Appl. No.: 17/846,853

(22) Filed: Jun. 22, 2022

(30) Foreign Application Priority Data
Mar. 22, 2022 (IN) 202241015836

(51) Int. Cl. G06F 40/232; G06F 40/284; G06F 40/58; G06F 16/332

(52) U.S. Cl. CPC G06F 40/232; G06F 40/284; G06F 40/58; G06F 16/3322

(57) ABSTRACT

A system and method for machine translation-based spelling correction is provided. The method includes receiving, by a processor associated with a system, a query from a user via an electronic device; analysing, by the processor, via an encoder, a fixed dimensional representation of the source sequence for each time step or a query token corresponding to the source sequence; generating, by the processor, via a decoder, a target token corresponding to the query token, based on the fixed dimensional representation; mapping, by the processor, via an attention model, one or more different source sequence representation and one or more relevant source sequence representation, corresponding to each of the target token generated by the decoder at each time step; and outputting, by the processor, one or more query-level candidates with corrected spellings corresponding to the received query, based on mapping.

### TECHNICAL FIELD

The present disclosure relates in general to spelling corrections in a query from a user. In particular, the present disclosure relates to machine learning assisted spelling corrections in a query from a user.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

E-commerce website users often make spelling mistakes while searching for products. This results in different or irrelevant products being retrieved by the system, thus negatively affecting the user experience. Users make a variety of errors while writing queries in English that can be broadly categorized in error classes such as edit errors, phonetic errors, compounding errors and words that have edit/phonetic as well as compounding errors. The presence of such varied error types pose a challenge while developing a spell correction module, as a system built for correcting a particular error class might perform poorly while correcting spelling errors of some other type. Further, some users may use other languages to pose queries.

Large scale spelling correction systems in web search have been generally implemented using edit distance model or noisy channel model. Edit distance based models find the correct words that are a given number of edits away from the incorrect input word. Whereas, noisy channel methods, such as Brill and Moore's noisy channel model, are statistical error models which assume that the user induces some typos or spelling errors while trying to type the right word. However, the edit distance based methods have high latencies and thus it is impractical to use them in web search. Also, they provide word-level corrections that fail to capture the contextual spelling mistakes that users make while searching for products, such as “sleeveless short”. Incorporating context in the spell correction module can also help in correcting errors that are contextual in nature and not specifically a spelling mistake.

Machine translation has also been used to implement spelling correction modules. However, machine translation based spell correction approaches require training data that consists of incorrect query (query with spelling error) along with its corresponding correct query. Further, such data is scarce and it is a tedious task to manually label correct spelling of large amounts of incorrect spellings.

There is therefore a requirement for a methodology to effectively handle query level spelling correction.

### SUMMARY

It is an object of the present invention to provide a system and a method for query-level spelling correction.

It is another object of the present invention to provide a system and method for machine learning-based spelling correction.

It is another object of the present invention to provide a system and method to determine spelling correction for a variety of error classes.

It is another object of the present invention to provide a system and method that can fine tune training data.

In a first aspect, the present disclosure provides a method for machine translation-based spelling correction. The method includes receiving, by a processor associated with a system, a query from a user via an electronic device. The query is converted to a source sequence including different words of the received query. The method further includes analyzing, by the processor, via an encoder, a fixed dimensional representation of the source sequence for each time step or a query token corresponding to the source sequence. The query token includes one or more token for each word of the received query. The method further includes generating, by the processor, via a decoder, a target token corresponding to the query token, based on the fixed dimensional representation. The generation of the target token in the decoder includes one word at each time step. The method further includes mapping, by the processor, via an attention model, one or more different source sequence representation and one or more relevant source sequence representation, corresponding to each of the target token generated by the decoder at each time step. The method further includes outputting, by the processor, one or more query-level candidates with corrected spellings corresponding to the received query, based on mapping the one or more different source sequence representation and the one or more relevant source sequence representation.

In a second aspect, the present disclosure provides a system for machine translation-based spelling correction. The system includes a processor and a memory coupled to the processor. The memory includes processor executable instructions, which on execution, causes the processor to receive a query from a user via an electronic device. The query is converted to a source sequence comprising different words of the received query. The processor is further configured to analyze, via an encoder, a fixed dimensional representation of the source sequence for each time step or a query token corresponding to the source sequence. The query token includes one or more token for each word of the received query. The processor is further configured to generate, via a decoder, a target token corresponding to the query token, based on the fixed dimensional representation. The generation of the target token in the decoder comprises one word at each time step. The processor is further configured to map via an attention model, one or more different source sequence representation and one or more relevant source sequence representation, corresponding to each of the target token generated by the decoder at each time step. The processor is further configured to output one or more query-level candidates with corrected spellings corresponding to the received query, based on mapping the one or more different source sequence representation and the one or more relevant source sequence representation.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry/subcomponents of each component. It will be appreciated by those skilled in the art that invention of such drawings includes the invention of electrical components, electronic components or circuitry commonly used to implement such components.

FIG. 1 illustrates an exemplary block diagram representation of a network architecture implementing a system for machine translation-based spelling correction, according to embodiments of the present disclosure;

FIG. 2 illustrates a detailed block diagram representation of the proposed system, according to embodiments of the present disclosure;

FIG. 3A illustrates an exemplary flow chart for a method to determine error model score for an edit error;

FIG. 3B illustrates an exemplary flow chart for a method to determine edit distance error words while translating words from one language to another;

FIG. 3C illustrates an exemplary flow chart for a method to determine probability of occurrence;

FIG. 3D illustrates an exemplary flow chart for a method to determine top-K query level spell corrected candidates;

FIG. 4 illustrates a flow chart for a method for machine-translation based spelling correction, according to an embodiment of the present disclosure; and

FIG. 5 illustrates a hardware platform 500 for implementation of the disclosed system 110, according to an example embodiment of the present disclosure

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, “connect”, “configure”, “couple” and its cognate terms, such as “connects”, “connected”, “configured” and “coupled” may include a physical connection (such as a wired/wireless connection), a logical connection (such as through logical gates of semiconducting device), other suitable connections, or a combination of such connections, as may be obvious to a skilled person.

As used herein, “send”, “transfer”, “transmit”, and their cognate terms like “sending”, “sent”, “transferring”, “transmitting”, “transferred”, “transmitted”, etc. include sending or transporting data or information from one unit or component to another unit or component, wherein the content may or may not be modified before or after sending, transferring, transmitting.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

In an aspect, the present disclosure provides a method for machine translation-based spelling correction. The method includes receiving, by a processor associated with a system, a query from a user via an electronic device. The query is converted to a source sequence including different words of the received query. The method further includes analysing, by the processor, via an encoder, a fixed dimensional representation of the source sequence for each time step or a query token corresponding to the source sequence. The query token includes one or more token for each word of the received query. The method further includes generating, by the processor, via a decoder, a target token corresponding to the query token, based on the fixed dimensional representation. The generation of the target token in the decoder includes one word at each time step. The method further includes mapping, by the processor, via an attention model, one or more different source sequence representation and one or more relevant source sequence representation, corresponding to each of the target token generated by the decoder at each time step. The method further includes outputting, by the processor, one or more query-level candidates with corrected spellings corresponding to the received query, based on mapping the one or more different source sequence representation and the one or more relevant source sequence representation.

In another aspect, the present disclosure provides a system for machine translation-based spelling correction. The system includes a processor and a memory coupled to the processor. The memory includes processor executable instructions, which on execution, causes the processor to receive a query from a user via an electronic device. The query is converted to a source sequence comprising different words of the received query. The processor is further configured to analyse, via an encoder, a fixed dimensional representation of the source sequence for each time step or a query token corresponding to the source sequence. The query token includes one or more token for each word of the received query. The processor is further configured to generate, via a decoder, a target token corresponding to the query token, based on the fixed dimensional representation. The generation of the target token in the decoder comprises one word at each time step. The processor is further configured to map via an attention model, one or more different source sequence representation and one or more relevant source sequence representation, corresponding to each of the target token generated by the decoder at each time step. The processor is further configured to output one or more query-level candidates with corrected spellings corresponding to the received query, based on mapping the one or more different source sequence representation and the one or more relevant source sequence representation.

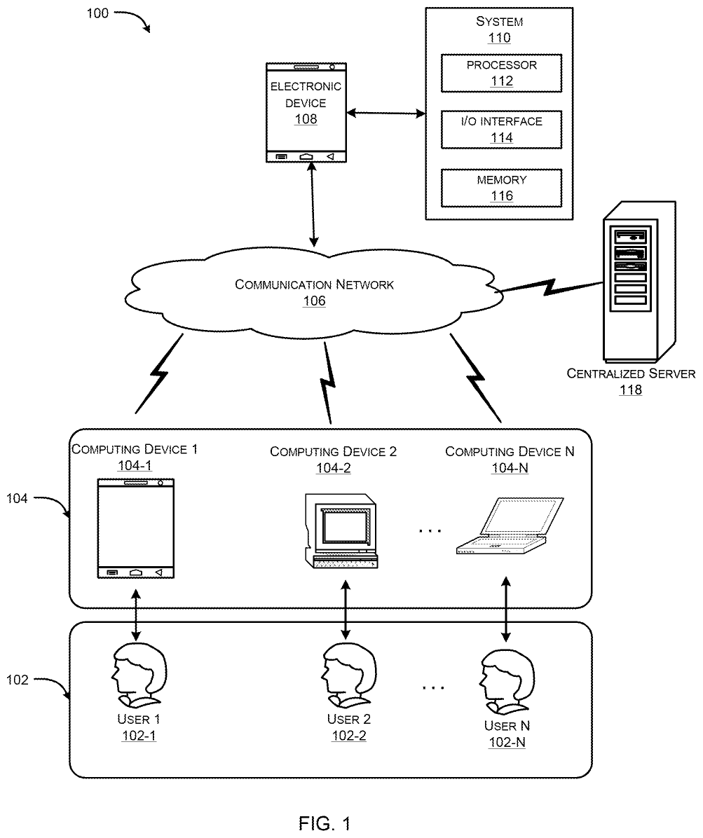

FIG. 1 illustrates an exemplary block diagram representation of a network architecture 100 implementing a system 110 for machine translation-based spelling correction, according to embodiments of the present disclosure. The network architecture 100 may include the system 110, an electronic device 108, and a server 118. The system 110 may be connected to the server 118 via a communication network 106. The server 118 may include, without limitations, a stand-alone server, a remote server, cloud computing server, a dedicated server, a rack server, a server blade, a server rack, a bank of servers, a server farm, hardware supporting a part of a cloud service or system, a home server, hardware running a virtualized server, one or more processors executing code to function as a server, one or more machines performing server-side functionality as described herein, at least a portion of any of the above, some combination thereof, and the like. The communication network 106 may be a wired communication network or a wireless communication network. The wireless communication network may be any wireless communication network capable to transfer data between entities of that network such as, but are not limited to, a carrier network including circuit switched network, a public switched network, a Content Delivery Network (CDN) network, a Long-Term Evolution (LTE) network, a Global System for Mobile Communications (GSM) network and a Universal Mobile Telecommunications System (UMTS) network, an Internet, intranets, local area networks, wide area networks, mobile communication networks, combinations thereof, and the like.

The system 110 may be implemented by way of a single device or a combination of multiple devices that may be operatively connected or networked together. For instance, the system 102 may be implemented by way of standalone device such as the server 118, and the like, and may be communicatively coupled to the electronic device 108. In another instance, the system 102 may be implemented in the electronic device 108. The electronic device 108 may be any electrical, electronic, electromechanical, and computing device. The electronic device 108 may include, without limitations, a mobile device, a smart phone, a Personal Digital Assistant (PDA), a tablet computer, a phablet computer, a wearable device, a Virtual Reality/Augment Reality (VR/AR) device, a laptop, a desktop, and the like.

In some embodiments, the system 110 may be communicably coupled to one or more computing devices 104. The one or more computing devices 104 may be associated with corresponding one or more users 102. For instance, the one or more computing devices 104 may include computing devices 104-1, 104-2 . . . 104-N, associated with corresponding users 102-1, 102-2 . . . 102-N. The one or more computing devices 104 may include, without limitations, a mobile device, a smart phone, a Personal Digital Assistant (PDA), a tablet computer, a phablet computer, a wearable device, a Virtual Reality/Augment Reality (VR/AR) device, a laptop, a desktop, and the like.

The system 110 may be implemented in hardware or a suitable combination of hardware and software. Further, the system 110 may include a processor 112, an Input/Output (I/O) interface 114, and a memory 116. The Input/Output (I/O) interface 114 on the system 110 may be used to receive input from a user.

Further, the system 110 may also include other units such as a display unit, an input unit, an output unit and the like, however the same are not shown in the FIG. 1, for the purpose of clarity. Also, in FIG. 1 only few units are shown, however the system 110 may include multiple such units or the system 110 may include any such numbers of the units, obvious to a person skilled in the art or as required to implement the features of the present disclosure. The system 110 may be a hardware device including the processor 112 executing machine-readable program instructions to perform machine translation-based spelling correction. Execution of the machine-readable program instructions by the processor 112 may enable the proposed system 110 to perform machine translation-based spelling correction. The “hardware” may include a combination of discrete components, an integrated circuit, an application-specific integrated circuit, a field programmable gate array, a digital signal processor, or other suitable hardware. The “software” may include one or more objects, agents, threads, lines of code, subroutines, separate software applications, two or more lines of code or other suitable software structures operating in one or more software applications or on one or more processors. The processor 112 may include, without limitations, microprocessors, microcomputers, microcontrollers, digital signal processors, central processing units, state machines, logic circuits, any devices that manipulate data or signals based on operational instructions, and the like. Among other capabilities, the processor 112 may fetch and execute computer-readable instructions in the memory 116 operationally coupled with the system 110 for performing tasks such as data processing, input/output processing, feature extraction, and/or any other functions. Any reference to a task in the present disclosure may refer to an operation being or that may be performed on data.

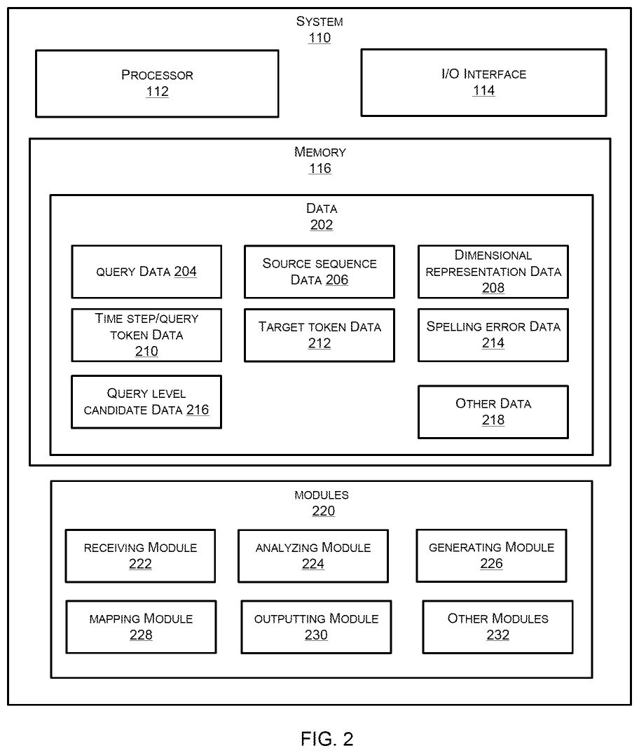

FIG. 2 illustrates a detailed block diagram representation of the proposed system 110, according to embodiments of the present disclosure. The system 110 may include the processor 112, the Input/Output (I/O) interface 114, and the memory 116. In some implementations, the system 110 may include data 202, and modules 220. As an example, the data 202 is stored in the memory 108 configured in the system 110 as shown in the FIG. 2. In an embodiment, the data 202 may include query data 204, source sequence data 206, dimensional representation data 208, time step/query token data 210, target token data 212, spelling error data 214, query level candidate data 216, and other data 218. In an embodiment, the data 202 may be stored in the memory 116 in the form of various data structures. Additionally, the data 202 can be organized using data models, such as relational or hierarchical data models. The other data 218 may store data, including temporary data and temporary files, generated by the module 220 for performing the various functions of the system 110.

In an embodiment, the modules 220 may include a receiving module 222, an analyzing module 224, a generating module 226, a mapping module 228, an outputting module 230, and other modules 228.

In an embodiment, the data 202 stored in the memory 116 may be processed by the modules 220 of the system 102. The modules 220 may be stored within the memory 116. In an example, the modules 220 communicatively coupled to the processor 112 configured in the system 110, may also be present outside the memory 116, and implemented as hardware. As used herein, the term modules refer to an Application-Specific Integrated Circuit (ASIC), an electronic circuit, a processor (shared, dedicated, or group) and memory that execute one or more software or firmware programs, a combinational logic circuit, and/or other suitable components that provide the described functionality.

Referring now to FIGS. 1 and 2, in an embodiment, the receiving module 222 is configured to receive a query from the user 102 via the electronic device 108. The data related to the query received from the user may be stored as the query data 204. The query may relate to a product that the user 102 may wish to search for. In an embodiment, the query is converted to a source sequence including different words of the received query. Data related to the source sequence may be stored as the source sequence data 206. In an embodiment, the analysing module 224 is configured to analyse via an encoder (not shown), a fixed dimensional representation of the source sequence for each time step or query token corresponding to the source sequence. The query token includes one or more tokens for each word of the received query. Data related to the fixed dimensional representation of the source sequence may be stored as the dimensional representation data 208. The fixed dimensional representation is obtained by compressing the source sequence, or the different words of the received query to a smaller dimension. The compression is carried out by the encoder. In an embodiment, the source sequence representation from the encoder is a weighted average of all the source sequence tokens representation to provide a context vector for the target token.

Data related to the time step of query token may be stored as the time step/query token data 210. Time step or query token refers to a word in the received query. Specifically, each word in the received query is associated with a different time step or query token. The fixed dimensional representation of source sequence is analysed iteratively one word at a time. In an embodiment, the generating module 226 is configured to generate, via a decoder (not shown), a target token corresponding to the query token, based on the fixed dimensional representation. The generation of the target token in the decoder includes one word for each time step. Data related to the target tokens may be stored as target token data 212. In an embodiment, the mapping module 228 may include an attention model. The mapping module 228 is configured to map, via the attention model, one or more different source sequence representations and one or more relevant source sequence representations corresponding to each of the target tokens generated by the decoder at each time step. In an embodiment, at each step the attention model consumes the previously generated target tokens as additional input when generating the next target tokens, and wherein the one or more relevant source sequence representation is a weighted context vector generated by the attention model.

In an embodiments, the outputting module 230 is configured to output one or more query-level candidate with corrected spellings corresponding to the received query, based on the mapping of the one or more source sequence representations and one or more relevant source sequence representations. Data related to the one or more query level candidates may be stored as query-level candidate data 216.

In some embodiments, based on the map of the one or more source sequence representations and one or more relevant source sequence representations, one or more spelling errors may be generated. Data related to the one or more spelling errors may be stored as spelling error data 214. In an embodiment, the processor is configured to generate training data. Further, for generating the training data, the processor is configured to generate the one or more spelling errors. In an embodiment, the one or more spelling errors may be associated with one or more error classes for the source sequence. The processor is configured to generate queries with spelling errors by replacing correct words with incorrect form in the query received from the user. The processor is further configured to train the attention model with synthetically generated training data, upon replacing correct words with incorrect form. The processor is further configured to obtain one or more corrected spellings, based on one or more user feedback, and applying required filters based on a Click Through Rate (CTR) for the corrected query and the generated target token. The processor is further configured to fine-tune the attention model with one or more user feedback for the one or more query-level candidates with the corrected spellings. The processor is further configured to output one or more top-K query-level candidates with corrected spellings corresponding to the received query, based on the one or more user feedback.

In an embodiment, the one or more errors classes includes at least one of user word errors, compounding errors, edit errors, phonetic errors, and edit/phonetic with compounding errors. In some embodiments, the edit errors are corrected based on edit distance-based spelling errors data generation. The processor is configured to determine edit distance-based spelling errors of the source sequence to synthetically generate one or more incorrect words of the source sequence based on mapping the one or more different source sequence representation and one or more relevant source sequence representation. The processor is further configured to validate one or more incorrect words generated based on the edit distance-based spelling errors, against the query received from the user. The processor is further configured to calculate an Error Model (EM) score for each of the validated one or more incorrect words against the query received from the user. In an embodiment, the synthetically generated one or more incorrect words is validated to verify that the synthetically generated one or more incorrect words are appeared in the query received from the user.

In an embodiment, the edit/phonetic with compounding errors is corrected based on edit/phonetic with compounding errors data generation. The processor is configured to determine a unigram or bigram from the source sequence. The processor is further configured to generate one or more bigram from the unigram, when the source sequence is the unigram, and splitting, the bigram, to obtain bigram tokens, when the source sequence is bigram. The processor is further configured to determine probability of occurrence in the query received from the user, for all the generated bigrams and choosing bigram with highest probability and splitting the bigram to obtain bigram tokens. The processor is further configured to obtain incorrect forms for all the bigram tokens from the edit/phonetic error dictionary, and replacing sequentially, one or more bigram tokens with the incorrect forms. The processor is further configured to join bigram tokens with space and without space to obtain incorrect bigrams and unigrams, respectively. The processor is further configured to determine probability of occurrence in the query received from the user for all incorrect bigrams and unigrams.

In an embodiment, the processor is further configured to induce an error in the query. The processor is configured to iterate through the query word by word and replace that word with an incorrect form, when the incorrect form exists in the mapping, to generate one or more incorrect queries from a single correct query received from the user. The processor is further configured to perform a second pass on the generated one or more incorrect queries to obtain incorrect queries with multiple misspelled words. The processor is further configured to replace bigrams with incorrect unigrams, to iterate through the query two words for each time step and considering the two words as a bigram.

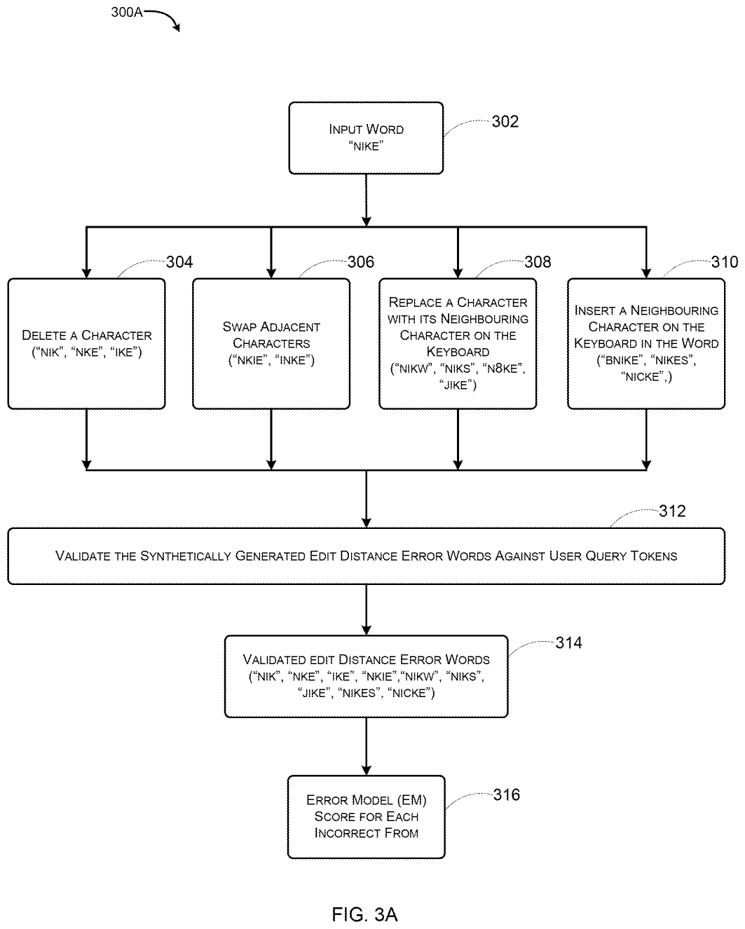

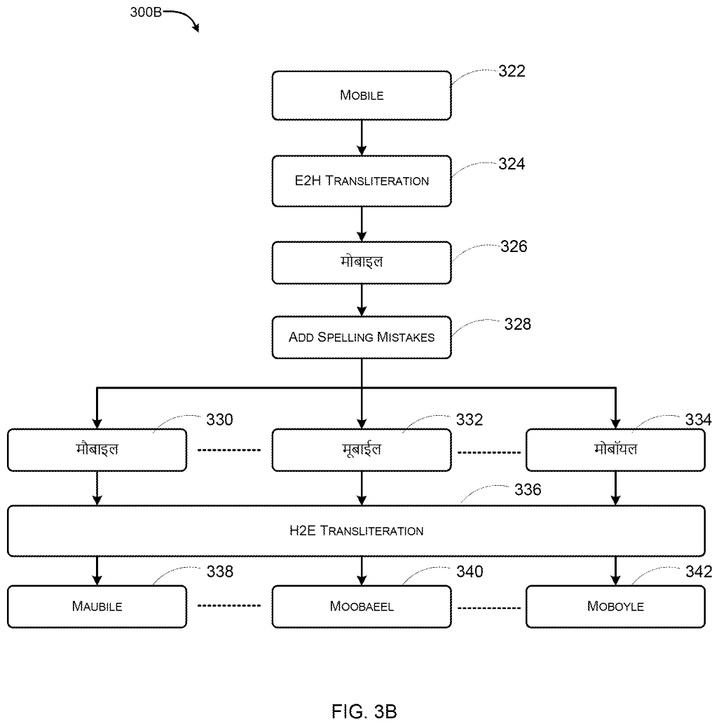

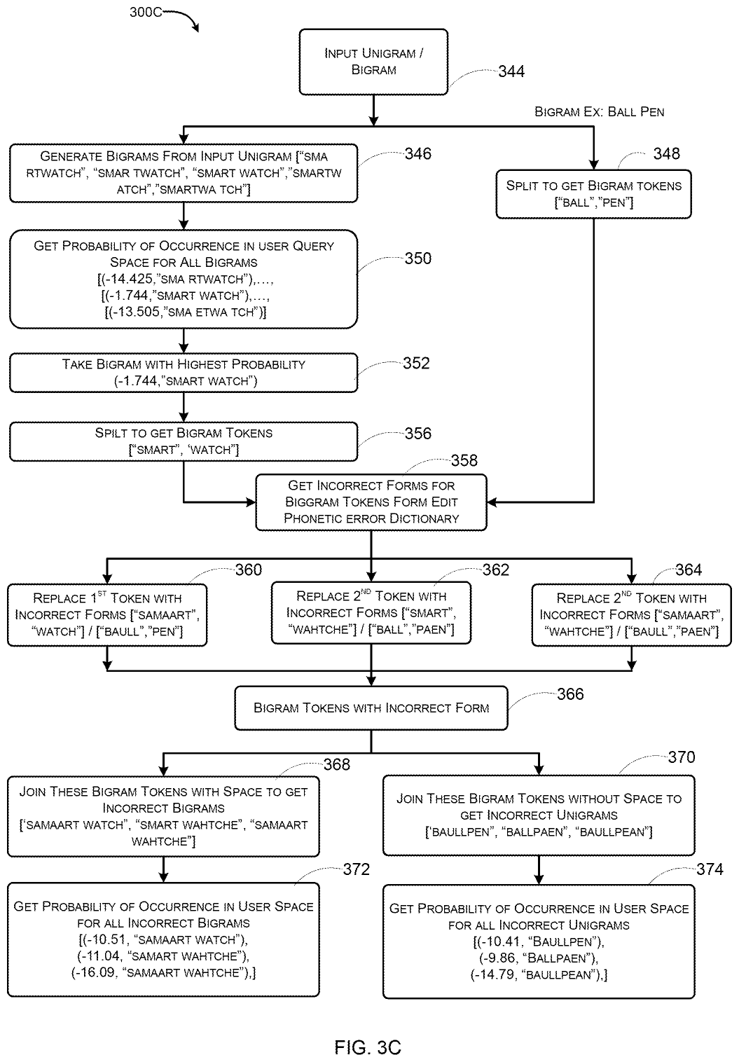

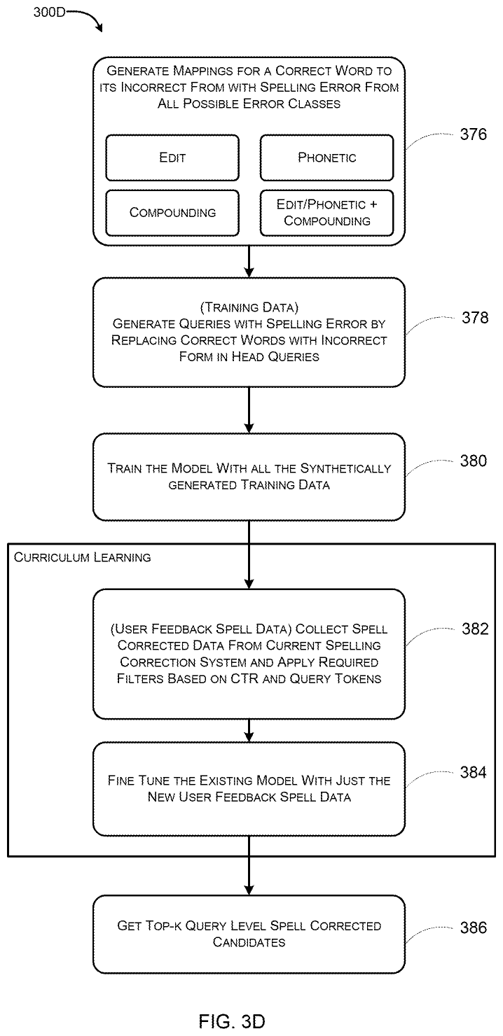

FIG. 3A illustrates an exemplary flow chart for a method 300A to determine error model score for an edit error. For instance, the input word may be “Nike”. At step 302, the method 300A includes inputting the word “Nike”. Steps 304 to 310 may include generating edit distance error words for the input word. At step 304, the method 300A includes deleting a character to determine an edit distance error word. For instance, the edit distance error word may be “Nik”, “Nke”, “Ike”, etc. At step 306, the method 300A includes swapping adjacent characters. For instance, the edit distance error word may be “Nkie”, “Inke”, etc. At step 308, the method 300A includes replacing a character with its neighboring character as provided on a keyboard. For instance, the edit distance error word may be “Nikw”, “Niks”, “N8ke”, “Jike”, etc. At step 310, the method 300A includes inserting a neighboring character as provided on the keyboard, in the input word. For instance, the edit distance error word may be “Bnike”, “Nikes”, “Nicke”, etc. At step 312, the method 300A includes validating the synthetically generated edit distance error words against user query tokens. At step 314, the method 300A includes validating edit distance error words. At step 316, the method 300A further includes determining the error model score for each incorrect form.

FIG. 3B illustrates an exemplary flow chart for a method 300B to determine edit distance error words while translating words from one language to another. For instance, the input word may be “Mobile”, and the translation may occur between Hindi and English. At step 322, the method 300B includes entering the input word “Mobile”. At step 324, the method 300B includes transliterating the term “Mobile” from English to Hindi. At step 326, the method 300B includes determining the Hindi script for the input word. At step 328, the method 300B includes adding spelling mistakes to the Hindi script. Steps 300 to 334 include adding spelling mistakes to the Hindi script of the input word. At step 336, the method 300B includes transliterating the misspelled Hindi words into English. For instance, the misspelled English words may be “Maubile” (step 338), “Moobaeel” (step 340), “Moboyle” (step 342), etc.

FIG. 3C illustrates an exemplary flow chart for a method 300C to determine probability of occurrence. At step 334, the method 300C includes inputting the unigram or bigram. For instance, a bigram may be “ball pen”, and the unigram may be “smartwatch”. At step 346, the method includes generating bigrams from the input unigram. For instance, the bigrams from the unigram “smartwatch” may be “smar twatch”, “smart watch”, “smartw atch”, “smartwa tch”, etc. At step, 348, the input bigram may be split to get bigram tokens, such as “ball” and “pen”. At step 350, a probability of occurrence in user query space for the bigrams is obtained. At step 352, the bigram with highest probability of occurrence is selected. For instance, the bigram with highest probability of occurrence may be “smart watch”. At step 356, the bigram is split to get bigram tokens. For instance, the bigram tokens may be “smart” and “watch”. At step 358, the incorrect forms for the bigram edits are obtained from the phonetic error dictionary. At step 360, the first token is replaced with incorrect forms. For instance, the incorrect forms may be “samaart watch”, “baull pen”, etc. At step 362, the second token is replaced with incorrect forms. For instance, the incorrect forms may be “smart wahtche”, “ball paen” etc. At step 364, the first and second tokens are replaced with incorrect forms. For instance, the incorrect forms may be “samaart wahtche”, “baull paen” etc. At step 366, bigram tokens of the incorrect forms are obtained. At step 368, the bigram tokens are joined with space to obtain incorrect bigrams. At step 370, bigram tokens are joined without space to obtain incorrect unigrams. At step 372, the probability of occurrence of the incorrect bigrams are determined. At step 374, the probability of occurrence of the incorrect unigrams are determined.

FIG. 3D illustrates an exemplary flow chart for a method 300D to determine top-K query level spell corrected candidates. At step 376, the method 300D includes generating mapping for correct word to its incorrect from the spelling error from all possible error classes. At step 378, the method 300D includes generating queries with spelling error by replacing correct words with incorrect form in head queries. At step 380, the method 300D includes training the model with all the synthetically generated training data. At step 382, the method 300D includes collecting spell corrected data from the current spelling correction system and applying the required filters based on CTR and query tokens. At step 384, the method 300D includes fine-tuning the exiting model with just the new user feedback spell data. At step 386, the method 300D includes generating Top-K query level spell corrected candidates.

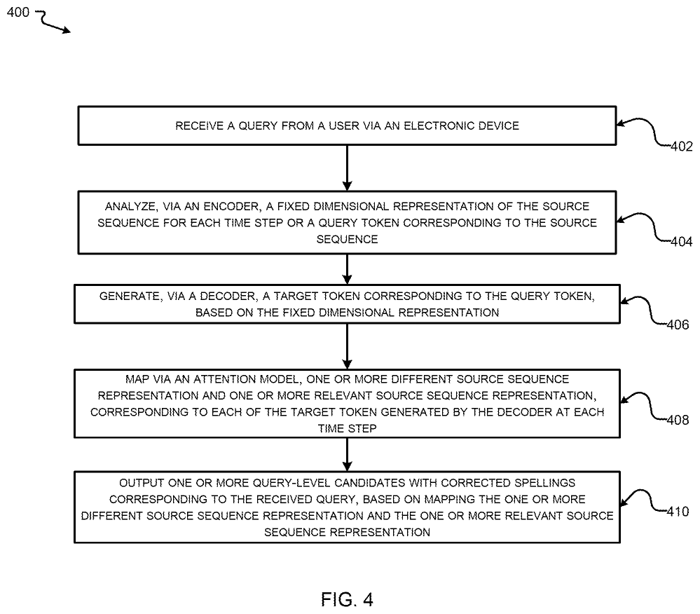

FIG. 4 illustrates a flow chart for a method 400 for machine-translation based spelling correction, according to an embodiment of the present disclosure. At step 402, the method includes receiving, by the processor associated with the system, a query from a user via an electronic device, wherein the query is converted to a source sequence comprising different words of the received query. At step. 404, the method 400 includes analyzing, by the processor, via an encoder, a fixed dimensional representation of the source sequence for each time step or a query token corresponding to the source sequence, and wherein the query token comprises one or more token for each word of the received query. At step 406, the method 400 includes generating, by the processor, via a decoder, a target token corresponding to the query token, based on the fixed dimensional representation, wherein the generation of the target token in the decoder comprises one word at each time step. At step 408, the method 400 includes mapping, by the processor, via an attention model, one or more different source sequence representation and one or more relevant source sequence representation, corresponding to each of the target token generated by the decoder at each time step. At step 410, the method 400 includes outputting, by the processor, one or more query-level candidates with corrected spellings corresponding to the received query, based on mapping the one or more different source sequence representation and the one or more relevant target sequence representation.

The order in which the method 400 are described is not intended to be construed as a limitation, and any number of the described method blocks may be combined or otherwise performed in any order to implement the method 400 or an alternate method. Furthermore, the method 400 may be implemented in any suitable hardware, software, firmware, or a combination thereof, that exists in the related art or that is later developed. The method 400 describe, without limitation, the implementation of the system 110. A person of skill in the art will understand that method 400 may be modified appropriately for implementation in various manners without departing from the scope and spirit of the disclosure.

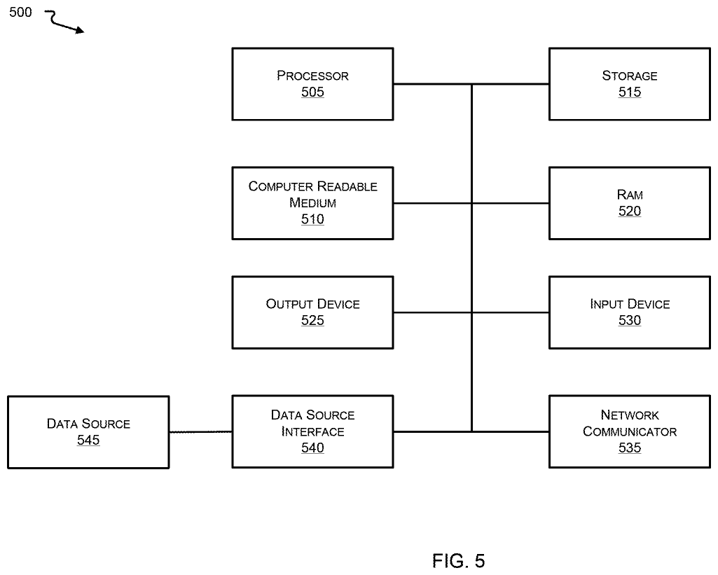

FIG. 5 illustrates a hardware platform 500 for implementation of the disclosed system 110, according to an example embodiment of the present disclosure. For the sake of brevity, construction, and operational features of the system 110 which are explained in detail above are not explained in detail herein. Particularly, computing machines such as but not limited to internal/external server clusters, quantum computers, desktops, laptops, smartphones, tablets, and wearables which may be used to execute the system 110 or may include the structure of the hardware platform 500. As illustrated, the hardware platform 500 may include additional components not shown, and that some of the components described may be removed and/or modified. For example, a computer system with multiple GPUs may be located on external-cloud platforms including Amazon® Web Services, or internal corporate cloud computing clusters, or organizational computing resources, etc.

The hardware platform 500 may be a computer system such as the system 110 that may be used with the embodiments described herein. The computer system may represent a computational platform that includes components that may be in a server or another computer system. The computer system may execute, by the processor 505 (e.g., a single or multiple processors) or other hardware processing circuit, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor 505 that executes software instructions or code stored on a non-transitory computer-readable storage medium 510 to perform methods of the present disclosure. The software code includes, for example, instructions to gather data and documents and analyze documents. In an example, the modules 220 may be software codes or components performing these steps.

The instructions on the computer-readable storage medium 510 are read and stored the instructions in storage 515 or in random access memory (RAM). The storage 515 may provide a space for keeping static data where at least some instructions could be stored for later execution. The stored instructions may be further compiled to generate other representations of the instructions and dynamically stored in the RAM such as RAM 520. The processor 505 may read instructions from the RAM 520 and perform actions as instructed.

The computer system may further include the output device 525 to provide at least some of the results of the execution as output including, but not limited to, visual information to users, such as external agents. The output device 525 may include a display on computing devices and virtual reality glasses. For example, the display may be a mobile phone screen or a laptop screen. GUIs and/or text may be presented as an output on the display screen. The computer system may further include an input device 530 to provide a user or another device with mechanisms for entering data and/or otherwise interact with the computer system. The input device 530 may include, for example, a keyboard, a keypad, a mouse, or a touchscreen. Each of these output devices 525 and input device 530 may be joined by one or more additional peripherals. For example, the output device 525 may be used to display the results such as bot responses by the executable chatbot.

A network communicator 535 may be provided to connect the computer system to a network and in turn to other devices connected to the network including other clients, servers, data stores, and interfaces, for instance. A network communicator 535 may include, for example, a network adapter such as a LAN adapter or a wireless adapter. The computer system may include a data sources interface 540 to access the data source 545. The data source 545 may be an information resource. As an example, a database of exceptions and rules may be provided as the data source 545. Moreover, knowledge repositories and curated data may be other examples of the data source 545.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

### Advantages of the Invention

The present invention provides a system and a method for query-level spelling correction.

The present invention provides a system and method for machine learning-based spelling correction.

The present invention provides a system and method to determine spelling correction for a variety of error classes.

The present invention provides a system and method that can fine tune training data.

We claim:

1. A method for machine translation-based spelling correction, the method comprising:
receiving, by a processor associated with a system, a query from a user via an electronic device, wherein the query is converted to a source sequence comprising different words of the received query;
analysing, by the processor, via an encoder, a fixed dimensional representation of the source sequence for each time step or a query token corresponding to the source sequence, and wherein the query token comprises one or more token for each word of the received query;
generating, by the processor, via a decoder, a target token corresponding to the query token, based on the fixed dimensional representation, wherein the generation of the target token in the decoder comprises one word at each time step;
mapping, by the processor, via an attention model, one or more different source sequence representation and one or more relevant source sequence representation, corresponding to each of the target token generated by the decoder at each time step;
and
outputting, by the processor, one or more query-level candidates with corrected spellings corresponding to the received query, based on mapping the one or more different source sequence representation and the one or more relevant target sequence representation.

2. The method as claimed in claim 1 further comprises generating of training data, which comprises generating, by the processor, one or more spelling errors associated with one or more errors classes for the source sequence, by:
generating, by the processor, queries with spelling errors by replacing correct words with incorrect form in the query received from the user;
training, by the processor, the attention model with synthetically generated training data, upon replacing correct words with incorrect form;
obtaining, by the processor, one or more corrected spellings, based on one or more user feedback, and applying required filters based on a Click Through Rate (CTR) for the corrected query and the generated target token;
fine-tuning, by the processor, the attention model with one or more user feedback for the one or more query-level candidates with the corrected spellings; and
outputting, by the processor, one or more top-K query-level candidates with corrected spellings corresponding to the received query, based on the one or more user feedback.

3. The method as claimed in claim 1, wherein the one or more errors classes comprises at least one of user word errors, compounding errors, edit errors, phonetic errors, and edit/phonetic with compounding errors.

4. The method as claimed in claim 3, wherein the edit errors is corrected based on edit distance-based spelling errors data generation, wherein the edit distance-based spelling errors data generation further comprises:
determining, by the processor, an edit distance-based spelling errors of the source sequence to synthetically generate one or more incorrect words of the source sequence, based on mapping the one or more different source sequence representation and one or more relevant source sequence representation;
validating, by the processor, one or more incorrect words generated based on the edit distance-based spelling errors, against the query received from the user; and
calculating, by the processor, an Error Model (EM) score for each of the validated one or more incorrect words against the query received from the user.

5. The method as claimed in claim 4, wherein the synthetically generated one or more incorrect words is validated to verify that the synthetically generated one or more incorrect words are appeared in the query received from the user.

6. The method as claimed in claim 3, wherein the edit/phonetic with compounding errors is corrected based on edit/phonetic with compounding errors data generation, wherein the edit/phonetic with compounding errors data generation further comprises:
determining, by the processor, a unigram or bigram from the source sequence;
generating, by the processor, one or more bigram from the unigram, when the source sequence is the unigram, and splitting, the bigram, to obtain bigram tokens, when the source sequence is bigram;
determining, by the processor, probability of occurrence in the query received from the user, for all the generated bigrams and choosing bigram with highest probability, and splitting the bigram to obtain bigram tokens;
obtaining, by the processor, incorrect forms for all the bigram tokens from the edit/phonetic error dictionary, and replacing sequentially, one or more bigram tokens with the incorrect forms;
joining, by the processor, bigram tokens with space and without space to obtain incorrect bigrams and unigrams, respectively; and
determining, by the processor, probability of occurrence in the query received from the user for all incorrect bigrams and unigrams.

7. The method as claimed in claim 1, wherein the source sequence representation from the encoder is a weighted average of all the source sequence tokens representation to provide a context vector for the target token.

8. The method as claimed in claim 1, wherein at each step the attention model consumes the previously generated target tokens as additional input when generating the next target tokens, and wherein the one or more relevant source sequence representation is a weighted context vector generated by the attention model.

9. The method as claimed in claim 1, wherein the method further comprises inducing, by the processor, error in the query, wherein inducing error in the query comprises:
iterating, by the processor, through the query word by word and replace that word with an incorrect form, when the incorrect form exists in the mapping, to generate one or more incorrect queries from a single correct query received from the user;
performing, by the processor, a second pass on the generated one or more incorrect queries to obtain incorrect queries with multiple misspelled words; and
replacing, by the processor, bigrams with incorrect unigrams, to iterate through the query two words for each time step and considering the two words as a bigram.

10. A system for machine translation-based spelling correction, the system comprising:
a processor; and
a memory coupled to the processor, wherein the memory comprises processor executable instructions, which on execution, causes the processor to:
receive a query from a user via an electronic device, wherein the query is converted to a source sequence comprising different words of the received query;
analyse, via an encoder, a fixed dimensional representation of the source sequence for each time step or a query token corresponding to the source sequence, and wherein the query token comprises one or more token for each word of the received query;
generate, via a decoder, a target token corresponding to the query token, based on the fixed dimensional representation, wherein the generation of the target token in the decoder comprises one word at each time step;
map via an attention model, one or more different source sequence representation and one or more relevant source sequence representation, corresponding to each of the target token generated by the decoder at each time step; and
output one or more query-level candidates with corrected spellings corresponding to the received query, based on mapping the one or more different source sequence representation and the one or more relevant source sequence representation.

11. The system as claimed in claim 10, wherein the processor is further configured to generate training data, for generating the training data, the processor is further configured to generate one or more spelling errors associated with one or more errors classes for the source sequence, by:
generating queries with spelling errors by replacing correct words with incorrect form in the query received from the user;
training the attention model with synthetically generated training data, upon replacing correct words with incorrect form;
obtaining one or more corrected spellings, based on one or more user feedback, and applying required filters based on a Click Through Rate (CTR) for the corrected query and the generated target token;
fine-tuning the attention model with one or more user feedback for the one or more query-level candidates with the corrected spellings; and
outputting one or more top-K query-level candidates with corrected spellings corresponding to the received query, based on the one or more user feedback.

12. The system as claimed in claim 10, wherein the one or more errors classes comprises at least one of user word errors, compounding errors, edit errors, phonetic errors, and edit/phonetic with compounding errors.

13. The system as claimed in claim 12, wherein the edit errors is corrected based on edit distance-based spelling errors data generation, wherein for the edit distance-based spelling errors data generation, the processor is further configured to:
determine an edit distance-based spelling errors of the source sequence to synthetically generate one or more incorrect words of the source sequence, based on mapping the one or more different source sequence representation and one or more relevant source sequence representation;
validate one or more incorrect words generated based on the edit distance-based spelling errors, against the query received from the user; and
calculate an Error Model (EM) score for each of the validated one or more incorrect words against the query received from the user.

14. The system as claimed in claim 13, wherein the synthetically generated one or more incorrect words is validated to verify that the synthetically generated one or more incorrect words are appeared in the query received from the user.

15. The system as claimed in claim 12, wherein the edit/phonetic with compounding errors is corrected based on edit/phonetic with compounding errors data generation, wherein for the edit/phonetic with compounding errors data generation, the processor is further configured to:
determine a unigram or bigram from the source sequence;
generate one or more bigram from the unigram, when the source sequence is the unigram, and splitting, the bigram, to obtain bigram tokens, when the source sequence is bigram;
determine probability of occurrence in the query received from the user, for all the generated bigrams and choosing bigram with highest probability, and splitting the bigram to obtain bigram tokens;
obtain incorrect forms for all the bigram tokens from the edit/phonetic error dictionary, and replacing sequentially, one or more bigram tokens with the incorrect forms;
join bigram tokens with space and without space to obtain incorrect bigrams and unigrams, respectively; and
determine probability of occurrence in the query received from the user for all incorrect bigrams and unigrams.

16. The system as claimed in claim 10, wherein the source sequence representation from the encoder is a weighted average of all the source sequence tokens representation to provide a context vector for the target token.

17. The system as claimed in claim 10, wherein at each step the attention model consumes the previously generated target tokens as additional input when generating the next target tokens, and wherein the one or more relevant source sequence representation is a weighted context vector generated by the attention model.

18. The system as claimed in claim 10 further comprises inducing, by the processor, error in the query, wherein for inducing error in the query, the processor is further configured to:
iterate through the query word by word and replace that word with an incorrect form, when the incorrect form exists in the mapping, to generate one or more incorrect queries from a single correct query received from the user;
perform a second pass on the generated one or more incorrect queries to obtain incorrect queries with multiple misspelled words; and
replace bigrams with incorrect unigrams, to iterate through the query two words for each time step and considering the two words as a bigram.
